(19) United States
(12) Patent Application Publication
(10) Pub. No.: US 2025/0323946 A1
(43) Pub. Date: Oct. 16, 2025

(54) DYNAMIC PRIVACY POLICY GENERATION AND MANAGEMENT PLATFORM

(71) Applicant: Privacy Bee, LLC, Roswell, GA (US)

(72) Inventor: Harry Maugans, Roswell, GA (US)

(21) Appl. No.: 18/637,191

(22) Filed: Apr. 16, 2024

(51) Int. Cl. H04L 9/40

(52) U.S. Cl. CPC H04L 63/20

(57) ABSTRACT

A method for managing privacy policies involves receiving a request from a corporate entity to monitor a privacy policy and obtaining business practice information from the corporate entity, including vendor, customer, and corporate information. The method utilizes this information and relevant privacy regulations to determine privacy policy clauses for a privacy policy. A first privacy policy is generated and provided to the corporate entity via a Uniform Resource Indicator (URI). The computing device continuously monitors the corporate entity for changes in business practice information or privacy regulations. Upon detecting changes, updated privacy policy clauses are determined, and an updated privacy policy is generated, replacing the original policy displayed through the URI.

### FIELD OF DISCLOSURE

The present disclosure generally relates to privacy policies, and more specifically to automatic generation and monitoring of privacy policies.

### BACKGROUND

Various methods and systems have been developed for managing privacy policies within corporate entities. Traditionally, privacy policy management involved manual review and updating of privacy policies based on changes in business practices and regulations. This manual process often led to inconsistencies, delays, and potential non-compliance with evolving privacy regulations. Additionally, the sheer volume of information to be considered, including vendor information, customer information, and corporate information, made it challenging to efficiently and effectively manage privacy policies.

Some existing approaches to privacy policy management have utilized software applications to assist in the creation and maintenance of privacy policies. These applications typically involve predefined templates or rules that can be customized based on the specific requirements of the corporate entity. While these tools have improved the efficiency of privacy policy management to some extent, they often lack the flexibility to adapt to dynamic changes in business practices and regulations. As a result, corporate entities may still face challenges in ensuring that their privacy policies remain up-to-date and compliant with the latest regulatory requirements.

In certain instances, corporate entities have employed third-party services or consultants to handle privacy policy management. These services may offer expertise in interpreting privacy regulations and tailoring privacy policies accordingly. However, relying on external entities for privacy policy management can be costly and may introduce delays in updating policies in response to changes in business practices or regulations. Moreover, the lack of direct control over the privacy policy creation process may limit the ability of corporate entities to customize policies to their specific needs. However, none of these approaches have provided a comprehensive solution that combines the features described in this disclosure.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Techniques described herein generally relate to the management of privacy policies through a computing device. A corporate entity may request generation and/or monitoring of a privacy policy, and the computing device may receive business practice information associated with the corporate entity, which may include details about vendors, customers, and/or the corporate entity itself. Based on this information and applicable regulations, the computing device may determine and generate one or more privacy policy clauses for a privacy policy to be associated with the corporate entity. The corporate entity may be provided with a URI that leads to the display of the generated privacy policy. The computing device may monitor for any changes in business practice information or regulations. Responsive to identifying any changes, the computing device may automatically update the privacy policy clauses. The updated privacy policy may be displayed using the same URI as the previous version(s) of the privacy policy. In this way the privacy policy may be seamlessly updated without requiring any action on the part of the corporate entity. Notifications regarding the updated privacy policy may be provided or delivered to end users and/or one or more stakeholders at the corporate entity.

The computing device may receive business practice information in various formats and/or may infer business practice information through monitoring activities on a corporate network. The computing device may be equipped to handle updates to privacy policies by determining changes in business practice information or regulatory requirements. If such changes occur, the computing device may select new clauses for inclusion and/or remove existing clauses from the privacy policy. The selected clauses may be selected based at least in part on geographical information pertaining to the corporate entity's operations, the locations of end users, the locations of vendors, the business practice area(s) of the corporate entity, and/or any other factors related to one or more privacy regulations. The system may be configured to monitor privacy regulations from multiple jurisdictions. These jurisdictions may include, but are not limited to, regions, countries, states, provinces, or territories where the corporate entity conducts business, where end users reside, or where vendors operate. Additionally or alternatively, the system may monitor privacy regulations promulgated by one or more non-governmental professional agencies. The system may adapt to the differing privacy requirements of each jurisdiction. This adaptation may occur as part of the system's functionality to ensure compliance with applicable privacy laws and regulations.

In some aspects, the techniques described herein relate to a method of privacy policy management including receiving, at a computing device, a request from a corporate entity to monitor a privacy policy. The device may receive, from the corporate entity, business practice information including one or more of: vendor information related to one or more vendors associated with the corporate entity, customer information related to one or more customers of the corporate entity, or corporate information associated with the corporate entity. The device may determine, based at least on the received information and one or more regulations regarding privacy policies, one or more privacy policy clauses for inclusion in a privacy policy, and may generate a first privacy policy based on the one or more determined privacy policy clauses. A Uniform Resource Indicator (URI) that causes display of the generated first privacy policy may be provided to the corporate entity. The computing device may monitor the corporate entity for changes in the business practice information and/or changes to the one or more regulations regarding privacy policies. Responsive to determining one or more changes, the device may determine one or more updated privacy policy clauses for inclusion in an updated privacy policy, and may generate the updated privacy policy based on the one or more updated privacy policy clauses, such that the URI causes display of the updated privacy policy in place of the first privacy policy.

In some aspects, the techniques described herein relate to a system including: at least one device having a hardware processor, and a memory for storing instructions. The instructions, when executed by the at least one device, cause the system to perform operations including receiving, at the computing device, from the corporate entity, business practice information including one or more of: vendor information related to one or more vendors associated with the corporate entity, customer information related to one or more customers of the corporate entity, or corporate information associated with the corporate entity. The system may determine, based at least on the received information and one or more regulations regarding privacy policies, one or more privacy policy clauses for inclusion in a privacy policy, and may generate a first privacy policy based on the one or more determined privacy policy clauses. The system may provide, to the corporate entity, a URI that causes display of the generated first privacy policy. The computing device may monitor the corporate entity for changes in the business practice information and/or changes to the one or more regulations regarding privacy policies. Responsive to determining one or more changes, the system may determine one or more updated privacy policy clauses for inclusion in an updated privacy policy, and generate the updated privacy policy based on the one or more updated privacy policy clauses, such that the URI causes display of the updated privacy policy in place of the first privacy policy.

In some aspects, the techniques described herein relate to one or more non-transitory computer readable media including instructions which, when executed by one or more hardware processors, causes performance of operations including receiving, at the computing device and from the corporate entity, business practice information including one or more of: vendor information related to one or more vendors associated with the corporate entity, customer information related to one or more customers of the corporate entity, or corporate information associated with the corporate entity. The computing device may determine, based at least on the received information and one or more regulations regarding privacy policies, one or more privacy policy clauses for inclusion in a privacy policy, and may generate a first privacy policy based on the one or more determined privacy policy clauses. A URI that causes display of the generated first privacy policy may be provided to the corporate entity. The computing device may monitor the corporate entity for changes in the business practice information or changes to the one or more regulations regarding privacy policies. Responsive to determining one or more changes, the computing device may determine one or more updated privacy policy clauses for inclusion in an updated privacy policy, and generate the updated privacy policy based on the one or more updated privacy policy clauses, such that the URI causes display of the updated privacy policy in place of the first privacy policy.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing a dynamic policy generation platform; and

FIG. 3 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of privacy policy generation and management, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

In some embodiments, a computing device may receive a request to oversee a privacy policy from a business entity. This device may also obtain information about the business's practices, which could include data about vendors, customers, or the company itself. The device may then determine clauses for a privacy policy, based on this information and certain privacy regulations. A privacy policy is created using these clauses. The business is provided with a link that, when accessed, displays this policy. The device may keep watch over the business for any changes in practice or relevant regulations, and may automatically update the privacy policy based on these changes.

Embodiments of the present disclosure may comprise methods, systems, and a computer readable medium comprising, but not limited to, at least one of the following:
A. A Business Practice Information Collection Module;
B. A Candidate Privacy Policy Clause Database;
C. A Policy Generating Module; and
D. A Monitoring Module.

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components as found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
receiving, at a computing device, a request from a corporate entity to monitor a privacy policy;
receiving, at the computing device, from the corporate entity, business practice information comprising one or more of:
   vendor information related to one or more vendors associated with the corporate entity,
   customer information related to one or more customers of the corporate entity,
   corporate information associated with the corporate entity;
determining, by the computing device and based at least on the received information and one or more regulations regarding privacy policies, one or more privacy policy clauses for inclusion in a privacy policy;
generating, at the computing device, a first privacy policy based on the one or more determined privacy policy clauses;
providing, to the corporate entity, a Uniform Resource Indicator (URI) that causes display of the generated first privacy policy;
monitoring, by the computing device, the corporate entity for changes in the business practice information or changes to the one or more regulations regarding privacy policies; and
responsive to determining one or more changes:
   determining one or more updated privacy policy clauses for inclusion in an updated privacy policy, and
   generating the updated privacy policy based on the one or more updated privacy policy clauses, such that the URI causes display of the updated privacy policy in place of the first privacy policy.

Although the aforementioned method has been described to be performed by a dynamic policy generation and management platform 100, it should be understood that computing device 300 may be used to perform the various stages of the method. Furthermore, in some embodiments, different operations may be performed by different networked elements in operative communication with computing device 300. For example, a plurality of computing devices may be employed in the performance of some or all of the stages in the aforementioned method. Moreover, a plurality of computing devices may be configured much like a single computing device 300. Similarly, an apparatus may be employed in the performance of some or all stages in the method. The apparatus may also be configured much like computing device 300.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

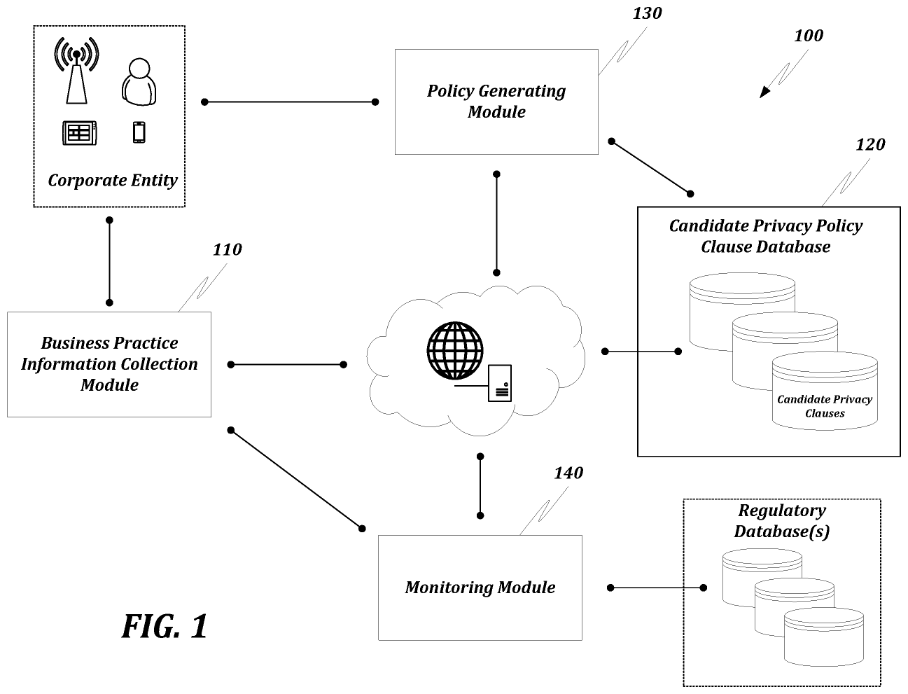

FIG. 1 illustrates one possible operating environment through which a platform consistent with embodiments of the present disclosure may be provided. By way of non-limiting example, a dynamic policy generation and management platform 100 may be hosted on, for example, a cloud computing service. In some embodiments, the platform 100 may be hosted on a computing device 300. A user may access platform 100 through a software application and/or hardware device. The software application may be embodied as, for example, but not be limited to, a website, a web application, a desktop application, and a mobile application compatible with the computing device 300.

Accordingly, embodiments of the present disclosure provide a software and hardware platform comprised of a distributed set of computing elements, including, but not limited to:

### A. A Business Practice Information Collection Module

In embodiments, the dynamic policy generation and management platform 100 may include a business practice information collection module 110. The business practice information collection module 110 may include hardware and/or software configured to perform one or more of the functions described herein. In particular, the business practice information collection module 110 may be configured to collect business practice information related to a corporate entity. The business practice information may include, but is not necessarily limited to, vendor information related to one or more vendors associated with the corporate entity, customer information related to one or more customers of the corporate entity, and/or corporate information associated with the corporate entity.

The vendor information may include details related to one or more vendors associated with a corporate entity. This may encompass vendor identifiers, which uniquely identify each vendor, location data associated with one or more (e.g., each) of the vendors, information specifying one or more industries served by one or more (e.g., each) vendor, privacy policy preferences or requirements associated with each vendor, and/or any other vendor information that may be useful in forming a privacy policy. The customer information may include personal details (e.g., demographic details, location details, etc.), purchase history, preferences, and/or any other customer information that may be relevant in forming a privacy policy. The corporate information may include the corporate entity's name, address, data regarding the corporate structure, such as departmental organization or hierarchy, the industries in which the corporation works (e.g., health care, financial, technology, etc.). the jurisdictions in which the corporation operates (e.g., where offices are located, where end users are located, where the company is headquartered, etc.), and/or any other corporate information that may be relevant in forming a privacy policy.

In some embodiments, the business practice information collection module 110 may receive at least a portion of the business practice information directly from the corporate entity. For example, the information may be provided as one or more text documents, one or more structured data documents (e.g., spreadsheets), or in any other way that clearly conveys the business practice information.

Additionally or alternatively, the business practice information collection module 110 may infer at least a portion of the business practice information based on activity within the corporate network. For example, the module 110 may analyze patterns of email traffic or document access logs. It may also monitor transaction records or employee timekeeping data to derive insights into business operations. The module may determine vendor lists and/or end user lists based on order traffic to and from the corporate entity.

### B. A Candidate Privacy Policy Clause Database

In embodiments, the dynamic policy generation and management platform 100 may include a candidate privacy policy clause database 120. The candidate privacy policy clause database 120 may include hardware and/or software configured to store and retrieve one or more candidate privacy policy clauses (e.g., for inclusion in a privacy policy).

The candidate privacy policy clause database 120 may include one or more data stores configured to store the candidate privacy policy clauses in a structured way, such that the candidate privacy policy clauses may be easily indexed, searched, and/or retrieved. In embodiments, the candidate privacy policy clauses may be stored in one or more relational databases, NoSQL databases, object-based storage systems, or other data storage systems that may allow for efficient organization and retrieval. These databases may be located on local servers and/or distributed systems. Additionally or alternatively, at least a portion of the one or more data stores hosted on cloud-based services. The data within these stores may be encrypted to enhance security. Data redundancy and backup procedures may be implemented to prevent data loss. In embodiments, the privacy policy candidate clause database may be updated periodically and/or intermittently, as new regulations require, as new clauses are used and/or tested, and/or for any other reasons.

### C. A Policy Generating Module

In embodiments, the dynamic policy generation and management platform 100 may include a policy generating module 130. The privacy policy generating module 130 may include hardware and/or software configured to generate a privacy policy. For example, In embodiments, the policy generating module 130 could access the candidate privacy policy clause database 120. The database 120 may contain a variety of privacy policy clauses tailored to different scenarios. The policy generating module 130 may select clauses based on predefined criteria. These criteria may relate to specific user inputs or requirements. For example, the criteria may be based on the business practice information collected be the module 110.

The generation of a privacy policy could involve compiling the selected clauses 150 into a cohesive document. For example, the policy generating module 130 may concatenate selected privacy policy terms to form a cohesive document and/or add selected privacy policy terms to a privacy policy template. In some embodiments, generating the privacy policy may include applying formatting (e.g., text color, underlining, italicizing, capitalizing, bolding, etc.) to one or more terms of the privacy policy.

The privacy policy generation module 130 may publish the generated privacy policy. For example, the module 130 may transmit the privacy policy to a user interface where it may be viewed by end users. Additionally or alternatively, the module 130 may be configured to electronically transmit and/or store the policy to a repository where it may be accessed. Furthermore, the policy may be incorporated into an application or a website, ensuring that users may review the policy before utilizing the platform. In embodiments, the module 130 may transmit, to the corporation, a Uniform Resource Indicator (URI) specifying the location of the privacy policy, such that actuation of the URI causes display of the privacy policy.

In some embodiments, the privacy policy generation module 130 may be configured to update a privacy policy. Updating a privacy policy may include removing one or more clauses from the privacy policy, adding one or more clauses to the privacy policy, and/or replacing an outdated version of a clause with a current version of the same clause. In embodiments, an updated privacy policy may be stored at the same location as the previous version of the privacy policy. In this way, the updated privacy policy can seamlessly replace the previous version of the privacy policy.

### D. A Monitoring Module

In embodiments, the dynamic policy generation and management platform 100 may include a monitoring module 140. The monitoring module 140 may include hardware and/or software configured to monitor business practice information associated with the corporation, privacy regulations, and/or privacy policy clause language for changes.

The monitoring module may monitor the business practice information associated with the corporation. In embodiments, monitoring the business practice information may include receiving updated business practice information from the corporation. Additionally or alternatively, the monitoring module 140 may infer changes to at least a portion of the business practice information based on activity within the corporate network. For example, the module 140 may analyze patterns of email traffic or document access logs. The module 140 may also monitor transaction records or employee timekeeping data to derive insights into business operations. The module 140 may determine vendor lists and/or end user lists based on order traffic to and from the corporate entity.

In embodiments, the monitoring module 140 may monitor for changes to one or more privacy regulations. For example, the module 140 may receive updates from one or more regulatory databases. The module 140 may periodically gather updated versions of regulations from one or more (e.g., each) regulatory organization and compare existing privacy policies against updated regulations. Notifications may be generated when discrepancies are identified. The system may be configured to adapt to new regulations automatically. Compliance reports may be generated periodically. These reports may reflect the current status of adherence of the candidate privacy policy clauses to privacy regulations. Adjustments to one or more of the candidate privacy policy clauses may be made based on these reports.

### III. Platform Operation

Talk about the steps your invention performs/how your invention operates/is used.

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method. The method may comprise the following stages:

The method may involve receiving a request from a corporate entity to monitor its privacy policy. The computing device may acquire business practice information from the corporate entity, which could include vendor information about the entity's vendors, customer information regarding its customers, and/or other corporate information. The process of receiving business practice information may be accomplished through direct input from the corporate entity, where the entity provides structured data files, or through automated monitoring, and/or inferring information based on activities on the corporate network.

Utilizing this information, along with relevant privacy regulations, the computing device determines suitable privacy policy clauses to be included in a privacy policy. The determination of suitable privacy policy clauses involves an analysis process where the computing device employs algorithms or rules-based logic to assess the business practice information against the framework of applicable privacy regulations. This assessment may take into account factors such as the nature of data collected, the purposes for data processing, data sharing practices, data retention periods, and the rights of data subjects. The computing device may select appropriate clauses from a structured data store containing a variety of candidate privacy clauses. These clauses are tailored to address specific legal requirements and business practices identified in the information provided by the corporate entity. The selection is made to ensure that the generated privacy policy accurately reflects the corporate entity's data handling practices and complies with current privacy laws and regulations.

Once the appropriate clauses are identified, the computing device generates a first privacy policy incorporating these clauses. The identified clauses, chosen based on their relevance to the corporate entity's business practices and applicable privacy regulations, are compiled and arranged into a coherent document. This document is then formatted to meet the requirements of a human-readable privacy policy. It is designed to be comprehensive and understandable to end-users who may interact with the corporate entity's services or products. The computing device ensures that the generated first privacy policy includes all necessary legal stipulations, definitions, user rights, and obligations of the corporate entity, creating a tailored privacy policy that reflects the specific operations and compliance needs of the corporate entity. To facilitate access to this privacy policy, the corporate entity is provided with a Uniform Resource Indicator (URI) which, when accessed, displays the generated privacy policy.

The computing device continues to monitor the corporate entity for any changes in its business practice information or alterations to the relevant privacy regulations. Upon detecting changes, the computing device updates the privacy policy clauses as necessary and generates an updated privacy policy to reflect these changes. The updated privacy policy is then made available through the same URI, replacing the original privacy policy. This ensures that the most current privacy practices are accessible and that the corporate entity remains in compliance with evolving privacy regulations.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components as found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

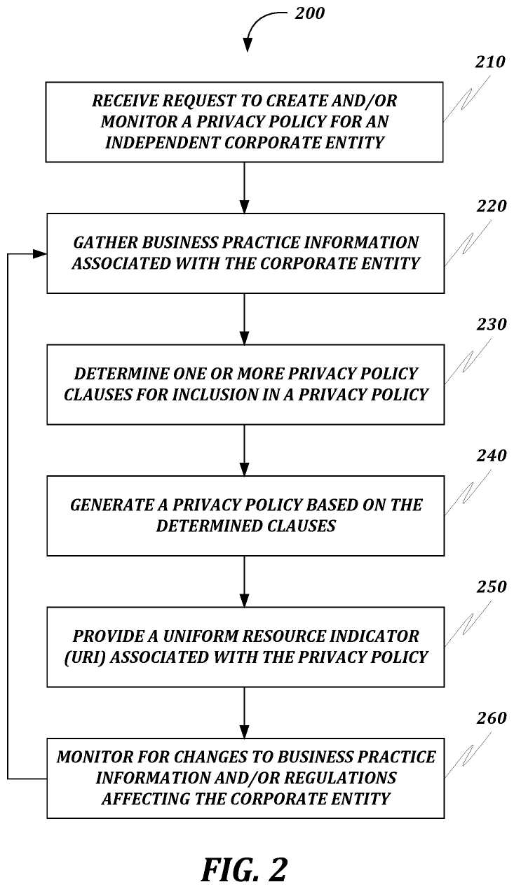

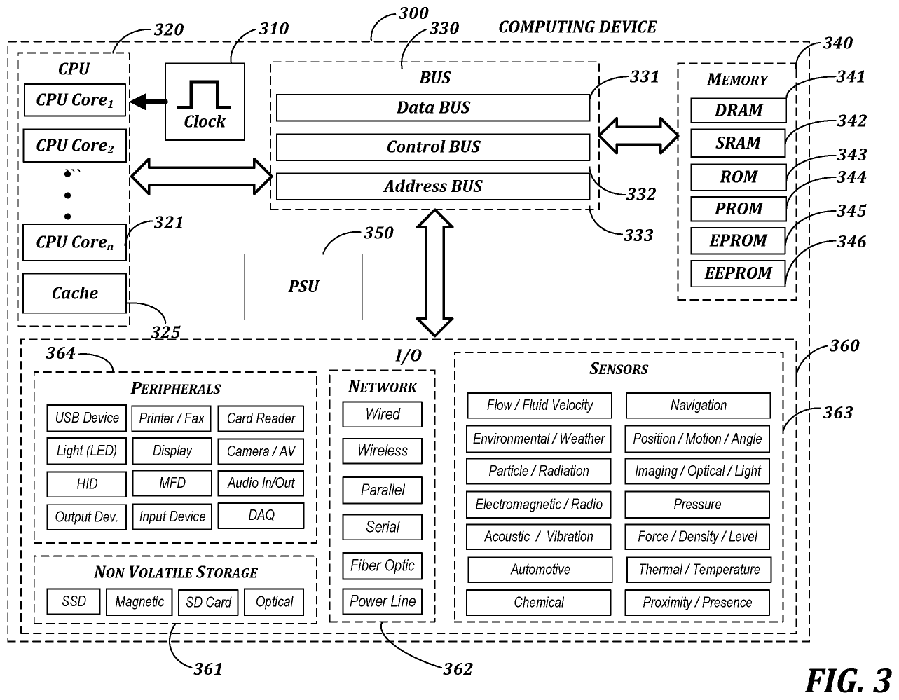

FIG. 2 is a flow chart setting forth the general stages involved in a method 200 consistent with an embodiment of the disclosure for providing platform 100. Method 200 may be implemented using a computing device 300 or any other component associated with platform 100 as described in more detail below with respect to FIG. 3. For illustrative purposes alone, computing device 300 is described as one potential actor in the following stages.

FIG. 2 is a flowchart of an example method for automated privacy policy generation and/or management. The method may begin with a computing device receiving a request to monitor a privacy policy. This request may originate from a corporate entity. Subsequently, the computing device may obtain business practice information, which may include details about vendors, customers, or the corporate entity itself. Based on this information and applicable privacy regulations, the computing device may determine clauses suitable for inclusion in a privacy policy. A privacy policy may then be generated by the computing device using the determined clauses. The corporate entity may be provided with a Uniform Resource Indicator (URI) that, when accessed, displays the generated privacy policy.

At step 210,, the computing device 300 may receive a request from an independent corporate entity to create and/or monitor a privacy policy. For example, the request may be transmitted electronically through various communication protocols, such as HTTP or HTTPS requests, from the corporate entity's systems to the computing device. Alternatively, the request may be received via an application programming interface (API) that one or more systems associated with the corporate entity utilize to communicate with the computing device.

In some embodiments, the corporate entity may be, for example, a business organization that engages in commercial, industrial, or professional activities. The corporate entity may be involved with various stakeholders, such as vendors and customers, and may operate in multiple geographical locations. It may have to comply with specific privacy regulations that are applicable to its operations and practices. In embodiments, the corporate entity is independent of (e.g., not owned or controlled by) an entity that controls the computing device 300.

The request may include various information. As examples, the request may include (but need not be limited to) corporate entity identifiers and details about the scope of monitoring desired by the corporate entity. The request may encompass specific parameters relating to the business practices of the corporate entity. For example, the parameter may include types of vendors associated with the corporate entity (e.g., health care institutions, financial institutions, technology companies, etc.), identification of one or more particular vendors associated with the corporate entity, customer demographics, the corporate entity's operational jurisdictions, the location of the corporate headquarters, and/or any other information pertinent to a privacy policy for the corporate entity.

At step 220, the computing device 300 may gather business practice information associated with the corporate entity. The business practice information may include one or more of: vendor information related to one or more vendors associated with the corporate entity, customer information related to one or more customers of the corporate entity, and/or corporate information associated with the corporate entity. In some embodiments, at least a portion of the business practice information may be provided by the corporate entity in the form of a structured data file. Additionally or alternatively, at least a portion of the business practice information may be determined by the computing device by monitoring activity on the corporate network, and inferring at least a portion of the business practice information based on the monitored activity.

The vendor information includes any information associated with vendors that serve the corporate entity. For example, vendor information may include data such as vendor names, contact details, services or goods provided by the vendors, transactional histories, and contractual terms. Vendor information may also encompass unique identifiers for each vendor, which allow for differentiation and specific recognition within a system managing the corporate entity's privacy policy. In some embodiments, the vendor information may include a business area in which the vendor practices, a geographic region in which the vendor operates, a location at which the vendor is headquartered, and/or any other information associated with the vendor.

The customer information related to one or more customers of the corporate entity may include, for example, details such as customer demographic data (e.g., an indicator of one or more of age, gender, nationality, ethnicity, etc.), location data (e.g., at least a portion of an address associated with the customer), purchase history, or service usage patterns. The customer information may be used to tailor privacy policy clauses that are relevant to the ways in which the corporate entity interacts with the customers and/or utilizes customer data.

The corporate information associated with the corporate entity may include, as examples, details such as the legal name of the corporate entity, its place of incorporation, and/or its corporate jurisdiction (e.g., where the corporate entity does business). The corporate information may encompass the types of products and/or services the corporate entity offers, its organizational structure, and/or any other relevant data that identifies the entity in a business context.

At step 230, the computing device 300 may determine one or more privacy policy clauses for inclusion in a privacy policy for the corporate entity. In some embodiments, the one or more privacy policy clauses may be determined based at least in part on the information received at stage 220 and/or one or more regulations regarding privacy policies. The regulations may be issued by a variety of governing bodies, which may include international organizations, national governments, state or provincial authorities, or local government entities. Alternatively or additionally, industry-specific regulations may be set forth by governing bodies with jurisdiction over particular business sectors. Still further, one or more companies associated with the corporation (e.g., one or more vendors, one or more customers, etc.) may issue regulations for privacy policies of organizations with which that company works.

In some embodiments, the one or more privacy policy clauses for inclusion in a privacy policy for the corporate entity may be selected from a database or other structured data store that includes a plurality of candidate privacy policy clauses. The clauses may be selected based at least on the received information and one or more regulations regarding privacy policies. The database may be updated intermittently (e.g., as privacy policies change) or periodically (e.g., daily, weekly, monthly) to ensure that the plurality of candidate privacy policies match current legal standards and/or corporate best practices.

At step 240, the computing device 300 may generate a first privacy policy based on the one or more determined privacy policy clauses. For example, the computing device may be configured to assemble a set of privacy policy clauses that are relevant to the specifics of the corporate entity's operations in a format that is human-readable and/or machine readable and compliant with one or more privacy regulations. As a particular example, the one or more determined privacy policy clauses may be concatenated with or otherwise inserted into a policy template. In some embodiments, generating the privacy policy may include formatting at least a portion of the privacy policy based on specific requirements or preferences. This formatting may take into account the visual presentation, such as the use of bold or italicized text, bullet points, or headings to emphasize certain sections or to enhance readability.

At step 250, the computing device may provide, to the corporate entity, a Uniform Resource Indicator (URI) that causes display of the generated first privacy policy. For example, the generated first privacy policy may be stored at a location that is publicly accessible (e.g., via the Internet). In particular, the first privacy policy may be stored at a location that is controlled by the owner of the computing device. The URI may be a link directly to the privacy policy such that actuation of the URI causes display of the privacy policy in a human-readable format. In some embodiments, providing the URI may include causing the corporate entity to publish the URI in a publicly available location (e.g., on the Internet, as a portion of a webpage associated with the corporate entity).

At step 260, the computing device 300 may monitor the corporate entity for changes in the business practice information and/or may monitor changes to the one or more regulations regarding privacy policies. For example, the method may return to stage 220 to gather updated business practice information.

In some aspects, the computing device may receive explicit changes to the corporate information associated with eh corporate entity. Alternatively, the computing device may infer changes in business practices or regulatory requirements by analyzing activities on a corporate network. For example, the addition of a new customer in a new country may have the effect of changing the area of operation of the corporate entity.

The computing device may access one or more regulatory databases to determine changes to one or more regulations. In some embodiments, the system may access the regulatory databases using one or more APIs associated therewith.

As one example, the computing device may determine changes by assessing business practice information and/or regulations concerning privacy policies. It may then update the privacy policy clauses based on these changes. In particular, the business practice information may include geographic details regarding the corporate entity's domicile, operational locations of the corporate entity, and/or the locations of associated end users. Monitoring by the computing device may involve looking for modifications in any of these geographic details. Changes detected in these geographic areas may prompt the selection of new clauses for the privacy policy, or the removal of existing ones. In particular, the computing device may track variations in the geographic information. This tracking may inform the updating of the privacy policy clauses. The changes may lead to a revised privacy policy that incorporates new clauses or removes previous clauses as appropriate.

As another example a computing device may manage a privacy policy by monitoring various regulations. For example, international, national, state, provincial, and/or local regulations may be monitored. Additionally or alternatively, the computing device may monitor industry-specific regulations from governing bodies with specified jurisdictions. The computing device may track location-data associated regulatory changes. This location data may be matched with geographical information related to a corporate entity. The geographical information may include where the entity is domiciled, operates, or the locations of associated end users.

In another scenario, a computing device may be configured to receive a list of vendors from a corporate entity. The computing device may monitor for the list for any additions and/or deletions. Additionally, the computing device may recognize changes to privacy policy requirements set forth by one or more (e.g., each) of these vendors. Upon detecting a change to the list of vendors device may determine whether the change in vendors necessitates a change in any privacy policy clauses. Similarly, in response to determining a change in privacy policy requirements for any vendor, the computing device may determine whether the vendor is on the list of vendors associated with the corporate entity. If a match is determined, this information may be used to adjust the privacy policy accordingly (e.g., by incorporating new clauses or removing previous clauses as appropriate).

Where the changes in business practice information include changes to end user parameters, the computing device may monitor for any additions or deletions to these parameters. These end user parameters may include (but are not limited to) identifiers, age data, and/or location data related to the end users. Upon determining changes to regulations regarding privacy policies that are based on end user information the computing device may establish whether there is a correspondence between these regulations and the end user parameters being monitored. If the privacy policy regulation changes do affect one or more of the end users, the computing device may update the privacy policy clauses to align with the new regulations (e.g., by incorporating new clauses or removing previous clauses as appropriate).

Responsive to determining one or more changes, the computing device 300 may determine one or more updated privacy policy clauses for inclusion in an updated privacy policy. In embodiments, the determining updates to privacy policy clauses may include selecting one or more new clauses for inclusion removing one or more existing clauses from a privacy policy, and/or updating language of one or more existing clauses (e.g., based on changes to a regulation).

As another example, where the updated business practice information includes a change to a list of industries in which the corporate entity operates, the computing device may monitor for additions or deletions to the list of industries. If there is a change in the regulations related to a particular industry, the process may include determining whether the affected industry matches an industry the corporate entity operates in. If there is a match, the computing device may adjust the privacy policy clauses to ensure compliance with the new or amended regulations (e.g., by incorporating new clauses or removing previous clauses as appropriate).

Based on the one or more updated privacy policy clauses, the computing device may generate an updated privacy policy. For example, the computing device may be configured to assemble a set of updated privacy policy clauses that are relevant to the specifics of the corporate entity's operations in a format that is human-readable and/or machine readable. As a particular example, the one or more updated privacy policy clauses may be concatenated with or otherwise inserted into the policy template. In some embodiments, generating the updated privacy policy may include formatting at least a portion of the updated privacy policy based on specific requirements or preferences. This formatting may take into account the visual presentation, such as the use of bold or italicized text, bullet points, or headings to emphasize certain sections or to enhance readability.

In embodiments, the computing device may replace any previous privacy policy (e.g., the first privacy policy) with the updated privacy policy, such that the URI causes display of the updated privacy policy in place of the previous privacy policy.

In some embodiments that computing device may provide, to the corporate entity, a notice of the one or more updated privacy policy clauses and/or a notice of the updated privacy policy. Each notice may be delivered to one or more end users at the corporate entity (e.g., a privacy office, a corporate compliance officer, etc.).

### IV. Computer Architecture

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 300. The computing device 300 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;

Platform 100 may be hosted on a centralized server or a cloud computing service. Although method 200 has been described to be performed by a computing device 300, it should be understood that, in some embodiments, different operations may be performed by a plurality of the computing devices 300 in operative communication on at least one network.

Embodiments of the present disclosure may comprise a system having a central processing unit (CPU) 320, a bus 330, a memory unit 340, a power supply unit (PSU) 350, and one or more Input/Output (I/O) units. The CPU 320 coupled to the memory unit 340 and the plurality of I/O units 360 via the bus 330, all of which are powered by the PSU 350. It should be understood that, in some embodiments, each disclosed unit may actually be a plurality of such units for redundancy, high availability, and/or performance purposes. The combination of the presently disclosed units is configured to perform the stages of any method disclosed herein.

FIG. 3 is a block diagram of a system including computing device 300. Consistent with an embodiment of the disclosure, the aforementioned CPU 320, the bus 330, the memory unit 340, a PSU 350, and the plurality of I/O units 360 may be implemented in a computing device, such as computing device 300 of FIG. 3. Any suitable combination of hardware, software, or firmware may be used to implement the aforementioned units. For example, the CPU 320, the bus 330, and the memory unit 340 may be implemented with computing device 300 or any of other computing devices 300, in combination with computing device 300. The aforementioned system, device, and components are examples and other systems, devices, and components may comprise the aforementioned CPU 320, the bus 330, and the memory unit 340, consistent with embodiments of the disclosure.

At least one computing device 300 may be embodied as any of the computing elements illustrated in all of the attached figures. A computing device 300 does not need to be electronic, nor even have a CPU 320, nor bus 330, nor memory unit 340. The definition of the computing device 300 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 300, especially if the processing is purposeful.

With reference to FIG. 3, a system consistent with an embodiment of the disclosure may include a computing device, such as computing device 300. In some configurations, the computing device 300 may include at least one clock module 310, at least one CPU 320, at least one bus 330, and at least one memory unit 340, at least one PSU 350, and at least one I/O 360 module, wherein I/O module may be comprised of, but not limited to a non-volatile storage sub-module 361, a communication sub-module 362, a sensors sub-module 363, and a peripherals sub-module 364.

In a system consistent with an embodiment of the disclosure, the computing device 300 may include the clock module 310, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 320, the central component of modern computers, which relies on a clock signal. The clock 310 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 300 may use a “clock multiplier” which multiplies a lower frequency external clock to the appropriate clock rate of the CPU 320. This allows the CPU 320 to operate at a much higher frequency than the rest of the computing device 300, which affords performance gains in situations where the CPU 320 does not need to wait on an external factor (like memory 340 or input/output 360). Some embodiments of the clock 310 may include dynamic frequency change, where, the time between clock edges can vary widely from one edge to the next and back again.

In a system consistent with an embodiment of the disclosure, the computing device 300 may include the CPU 320 comprising at least one CPU Core 321. In other embodiments, the CPU 320 may include a plurality of identical CPU cores 321, such as, but not limited to, homogeneous multi-core systems. It is also possible for the plurality of CPU cores 321 to comprise different CPU cores 321, such as, but not limited to, heterogeneous multi-core systems, big.LITTLE systems and some AMD accelerated processing units (APU). The CPU 320 reads and executes program instructions which may be used across many application domains, for example, but not limited to, general purpose computing, embedded computing, network computing, digital signal processing (DSP), and graphics processing (GPU). The CPU 320 may run multiple instructions on separate CPU cores 321 simultaneously. The CPU 320 may be integrated into at least one of a single integrated circuit die, and multiple dies in a single chip package. The single integrated circuit die and/or the multiple dies in a single chip package may contain a plurality of other elements of the computing device 300, for example, but not limited to, the clock 310, the bus 330, the memory 340, and I/O 360.

The CPU 320 may contain cache 322 such as but not limited to a level 1 cache, a level 2 cache, a level 3 cache, or combinations thereof. The cache 322 may or may not be shared amongst a plurality of CPU cores 321. The cache 322 sharing may comprise at least one of message passing and inter-core communication methods used for the at least one CPU Core 321 to communicate with the cache 322. The inter-core communication methods may comprise, but not be limited to, bus, ring, two-dimensional mesh, and crossbar. The aforementioned CPU 320 may employ symmetric multiprocessing (SMP) design.

The one or more CPU cores 321 may comprise soft microprocessor cores on a single field programmable gate array (FPGA), such as semiconductor intellectual property cores (IP Core). The architectures of the one or more CPU cores 321 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 321, for example, but not limited to Instruction-level parallelism (ILP) such as, but not limited to, superscalar pipelining, and Thread-level parallelism (TLP).

Consistent with the embodiments of the present disclosure, the aforementioned computing device 300 may employ a communication system that transfers data between components inside the computing device 300, and/or the plurality of computing devices 300. The aforementioned communication system will be known to a person having ordinary skill in the art as a bus 330. The bus 330 may embody internal and/or external hardware and software components, for example, but not limited to a wire, an optical fiber, various communication protocols, and/or any physical arrangement that provides the same logical function as a parallel electrical bus. The bus 330 may comprise at least one of a parallel bus, wherein the parallel bus carries data words in parallel on multiple wires; and a serial bus, wherein the serial bus carries data in bit-wise serial form. The bus 330 may embody a plurality of topologies, for example, but not limited to, a multidrop/electrical parallel topology, a daisy chain topology, and connected by switched hubs, such as a USB bus. The bus 330 may comprise a plurality of embodiments, for example, but not limited to:
Internal data bus (data bus) 331/Memory bus
Control bus 332
Address bus 333
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 300 may employ hardware integrated circuits that store information for immediate use in the computing device 300, known to persons having ordinary skill in the art as primary storage or memory 340. The memory 340 operates at high speed, distinguishing it from the non-volatile storage sub-module 361, which may be referred to as secondary or tertiary storage, which provides relatively slower-access to information but offers higher storage capacity. The data contained in memory 340, may be transferred to secondary storage via techniques such as, but not limited to, virtual memory and swap. The memory 340 may be associated with addressable semiconductor memory, such as integrated circuits consisting of silicon-based transistors, that may be used as primary storage or for other purposes in the computing device 300. The memory 340 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 341, Static Random-Access Memory (SRAM) 342, CPU Cache memory 325, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 343, Programmable ROM (PROM) 344, Erasable PROM (EPROM) 345, Electrically Erasable PROM (EEPROM) 346 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 300 may employ a communication system between an information processing system, such as the computing device 300, and the outside world, for example, but not limited to, human, environment, and another computing device 300. The aforementioned communication system may be known to a person having ordinary skill in the art as an Input/Output (I/O) module 360. The I/O module 360 regulates a plurality of inputs and outputs with regard to the computing device 300, wherein the inputs are a plurality of signals and data received by the computing device 300, and the outputs are the plurality of signals and data sent from the computing device 300. The I/O module 360 interfaces with a plurality of hardware, such as, but not limited to, non-volatile storage 361, communication devices 362, sensors 363, and peripherals 364. The plurality of hardware is used by at least one of, but not limited to, humans, the environment, and another computing device 300 to communicate with the present computing device 300. The I/O module 360 may comprise a plurality of forms, for example, but not limited to channel I/O, port mapped I/O, asynchronous I/O, and Direct Memory Access (DMA).

Consistent with the embodiments of the present disclosure, the aforementioned computing device 300 may employ a non-volatile storage sub-module 361, which may be referred to by a person having ordinary skill in the art as one of secondary storage, external memory, tertiary storage, off-line storage, and auxiliary storage. The non-volatile storage sub-module 361 may not be accessed directly by the CPU 320 without using an intermediate area in the memory 340. The non-volatile storage sub-module 361 may not lose data when power is removed and may be orders of magnitude less costly than storage used in memory 340. Further, the non-volatile storage sub-module 361 may have a slower speed and higher latency than in other areas of the computing device 300. The non-volatile storage sub-module 361 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (361) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 300 may employ a communication sub-module 362 as a subset of the I/O module 360, which may be referred to by a person having ordinary skill in the art as at least one of, but not limited to, a computer network, a data network, and a network. The network may allow computing devices 300 to exchange data using connections, which may also be known to a person having ordinary skill in the art as data links, which may include data links between network nodes. The nodes may comprise networked computer devices 300 that may be configured to originate, route, and/or terminate data. The nodes may be identified by network addresses and may include a plurality of hosts consistent with the embodiments of a computing device 300. Examples of computing devices that may include a communication sub-module 362 include, but are not limited to, personal computers, phones, servers, drones, and networking devices such as, but not limited to, hubs, switches, routers, modems, and firewalls.

Two nodes can be considered networked together when one computing device 300 can exchange information with the other computing device 300, regardless of any direct connection between the two computing devices 300. The communication sub-module 362 supports a plurality of applications and services, such as, but not limited to World Wide Web (WWW), digital video and audio, shared use of application and storage computing devices 300, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPV6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 362 may comprise a plurality of size, topology, traffic control mechanisms and organizational intent policies. The communication sub-module 362 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 300 may employ a sensors sub-module 363 as a subset of the I/O 360. The sensors sub-module 363 comprises at least one of the device, module, or subsystem whose purpose is to detect events or changes in its environment and send the information to the computing device 300. Sensors may be sensitive to the property they are configured to measure, may not be sensitive to any property not measured but be encountered in its application, and may not significantly influence the measured property. The sensors sub-module 363 may comprise a plurality of digital devices and analog devices, wherein if an analog device is used, an Analog to Digital (A-to-D) converter must be employed to interface the said device with the computing device 300. The sensors may be subject to a plurality of deviations that limit sensor accuracy. The sensors sub-module 363 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 300 may employ a peripherals sub-module 364 as a subset of the I/O 360. The peripheral sub-module 364 comprises ancillary devices uses to put information into and get information out of the computing device 300. There are 3 categories of devices comprising the peripheral sub-module 364, which exist based on their relationship with the computing device 300, input devices, output devices, and input/output devices. Input devices send at least one of data and instructions to the computing device 300. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 300. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 364:
Input Devices.
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 300. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 300 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 300. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 362), data storage devices (non-volatile storage 361), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### V. Aspects

The following discloses various Aspects of the present disclosure. The various Aspects are not to be construed as patent claims unless the language of the Aspect appears as a patent claim. The Aspects describe various non-limiting embodiments of the present disclosure.

Aspect 1. A method of privacy policy management comprising: receiving, at a computing device, a request from a corporate entity to monitor a privacy policy; receiving, at the computing device, from the corporate entity, business practice information comprising one or more of: vendor information related to one or more vendors associated with the corporate entity, customer information related to one or more customers of the corporate entity, corporate information associated with the corporate entity; determining, by the computing device and based at least on the received information and one or more regulations regarding privacy policies, one or more privacy policy clauses for inclusion in a privacy policy; generating, at the computing device, a first privacy policy based on the one or more determined privacy policy clauses; providing, to the corporate entity, a Uniform Resource Indicator (URI) that causes display of the generated first privacy policy; monitoring, by the computing device, the corporate entity for changes in the business practice information or changes to the one or more regulations regarding privacy policies; and responsive to determining one or more changes: determining one or more updated privacy policy clauses for inclusion in an updated privacy policy, generating the updated privacy policy based on the one or more updated privacy policy clauses, such that the URI causes display of the updated privacy policy in place of the first privacy policy.

Aspect 2. The method of any previous Aspect, further comprising: responsive to determining the one or more changes, providing, to the corporate entity, a notice to be delivered to one or more end users related to the updated privacy policy.

Aspect 3. The method of any previous Aspect, further comprising: responsive to determining the one or more changes, causing a notice related to the updated privacy policy to be delivered to one or more end users.

Aspect 4. The method of any previous Aspect, wherein determining the one or more changes comprises: determining a change in one or more of the business practice information and the one or more regulations regarding privacy policies, and wherein determining one or more updated privacy clauses comprises one or more of: based on the change, selecting one or more clauses of the first privacy policy for removal, or based on the change, selecting one or more clauses for inclusion in the updated privacy policy.

Aspect 5. The method of any previous Aspect, wherein the business practice information comprises one or more of: first geographical information related to where the corporate entity is domiciled, second geographical information related to one or more locations in which the corporate entity operates, or third geographical information related to one or more end users associated with the corporate entity; and wherein monitoring the corporate entity for changes comprises monitoring for changes in one or more of the first geographical information, the second geographical information, or the third geographical information.

Aspect 6. The method of any previous Aspect, wherein determining the one or more changes comprises: determining a change in one or more of the first geographical information, the second geographical information, or the third geographical information, and wherein determining one or more updated privacy clauses comprises one or more of: based on the change, selecting one or more clauses of the first privacy policy for removal, or based on the change, selecting one or more clauses for inclusion in the updated privacy policy.

Aspect 7. The method of any previous Aspect, wherein the one or more regulations regarding privacy policies comprises one or more of: an international regulation, a national regulation, a state or provincial regulation, a local regulation, a regulation issued by one or more governing bodies of an industry, wherein the governing body has a specified jurisdiction; and wherein monitoring the corporate entity for changes to the one or more regulations regarding privacy policies comprises: determining a location associated with the changes to the one or more regulations regarding privacy policies, and determining a match between the location associated with the changes to the one or more regulations regarding privacy policies and one or more of the first geographic information, the second geographic information, and the third geographic information.

Aspect 8. The method of any previous Aspect, wherein the business practice information comprises a vendor list including one or more vendor identifiers, each vendor identifier uniquely identifying a vendor, and wherein monitoring the corporate entity for changes comprises monitoring for: additions to the vendor list, or deletions from the vendor list.

Aspect 9. The method of any previous Aspect, wherein the one or more regulations regarding privacy policies comprises one or more requirements issued by one or more corporations; and wherein monitoring the corporate entity for changes to the one or more regulations regarding privacy policies comprises: determining a corporation associated with the changes to the one or more regulations regarding privacy policies, and determining a match between the corporation associated with the changes to the one or more regulations regarding privacy policies and a corporation associated with one or more of the vendor identifiers in the vendor list.

Aspect 10. The method of any previous Aspect, wherein the business practice information comprises one or more end user parameters, including at least one of: end user identifier, age data related to one or more end users, or location data associated with one or more end users, and wherein monitoring the corporate entity for changes comprises monitoring for: additions to the one or more end user parameters, or deletions from the one or more end user parameters.

Aspect 11. The method of any previous Aspect, wherein the one or more regulations regarding privacy policies comprises one or more regulations based on information associated with an end user, the information comprising one or more of age or location of the end user; and wherein monitoring the corporate entity for changes to the one or more regulations regarding privacy policies comprises: determining end user information associated with the changes to the one or more regulations regarding privacy policies, and determining a match between the end user information associated with the changes to the one or more regulations regarding privacy policies and end user information associated with one or more of the end users in the end user parameters.

Aspect 12. The method of any previous Aspect, wherein the business practice information comprises a list including one or more industries in which the corporate entity operates, and wherein monitoring the corporate entity for changes comprises monitoring for: additions to the one or more industries, or deletions from the one or more industries.

Aspect 13. The method of any previous Aspect, wherein the one or more regulations regarding privacy policies comprises one or more regulations associated with a particular industry; and wherein monitoring the corporate entity for changes to the one or more regulations regarding privacy policies comprises: determining an industry associated with the changes to the one or more regulations regarding privacy policies, and determining a match between the industry associated with the changes to the one or more regulations regarding privacy policies and the one or more industries in which the corporate entity operates.

Aspect 14. The method of any previous Aspect, wherein the corporate entity is independent of and does not control the computing device.

Aspect 15. The method of any previous Aspect, wherein determining the one or more privacy policy clauses for inclusion in a privacy policy comprises selecting one or more privacy policy clauses from a structured data store comprising a plurality of candidate privacy clauses, wherein the clauses are selected based at least on the received information and one or more regulations regarding privacy policies.

Aspect 16. The method of any previous Aspect, wherein generating the first privacy policy comprises publishing the first privacy policy in a human-readable form compliant with one or more privacy regulations.

Aspect 17. The method of any previous Aspect, wherein generating the updated privacy policy comprises replacing the first privacy policy with the updated privacy policy.

Aspect 18. The method of any previous Aspect, wherein receiving the business practice information comprises the corporate entity providing at least a portion of the business practice information as a structured data file.

Aspect 19. The method of any previous Aspect, wherein receiving the business practice information comprises: monitoring activity on a corporate network, and inferring at least a portion of the business practice information based on the monitored activity.

Aspect 20. The method of any previous Aspect, wherein providing the URI comprises causing the corporate entity to publish the URI in a publicly available location.

Aspect 21. A privacy policy management system comprising: A computing device configured to: Receive a request from a corporate entity to monitor a privacy policy; Acquire business practice information from the corporate entity, including vendor, customer, and corporate information; Determine privacy policy clauses based on the acquired information and applicable privacy regulations; Generate a privacy policy incorporating the determined clauses; Provide a Uniform Resource Indicator (URI) linked to the generated privacy policy for display; Monitor for changes in the business practice information or privacy regulations; and Update the privacy policy with new clauses in response to detected changes, wherein the URI displays the updated privacy policy.

Aspect 22. The system of any previous Aspect, wherein the computing device is further configured to: Provide a notification to the corporate entity when the privacy policy is updated.

Aspect 23. The system of any previous Aspect, wherein the computing device is further configured to: Generate a human-readable report summarizing the changes between the first privacy policy and the updated privacy policy.

Aspect 24. The system of any previous Aspect, wherein the computing device is further configured to: Receive the business practice information as a structured data file from the corporate entity.

Aspect 25. A system for dynamic privacy policy management, comprising: Means for receiving a monitoring request and business practice information from a corporate entity; Means for determining applicable privacy policy clauses based on the received information and privacy regulations; Means for generating a privacy policy document that includes the determined clauses; Means for providing a URI for accessing the generated privacy policy; Means for monitoring the corporate entity's business practices and regulatory changes; and Means for updating the privacy policy and the URI display in response to identified changes in business practices or regulations.

Aspect 26. The system of any previous Aspect, wherein the means for monitoring further includes: A network activity analyzer to infer changes in business practice information based on activity within the corporate entity's network.

Aspect 27. The system of any previous Aspect, wherein the means for providing a URI further includes: A publication module to facilitate the corporate entity in publishing the URI in a publicly accessible location.

Aspect 28. The system of any previous Aspect, wherein the means for updating the privacy policy further includes: A clause revision module to selectively add or remove clauses based on the identified changes.

Aspect 29. A computing system for automated privacy policy administration, comprising: A processor configured to process business practice information and privacy regulations; A memory coupled to the processor, storing instructions that, when executed by the processor, cause the system to: Receive a request to monitor and manage a privacy policy for a corporate entity; Determine necessary privacy policy clauses based on the business practice information and privacy regulations; Generate an initial privacy policy with the determined clauses; Issue a URI for accessing the generated privacy policy; Continuously monitor for any changes in the corporate entity's business practices or applicable privacy regulations; and Automatically generate and replace the initial privacy policy with an updated privacy policy upon detecting relevant changes, maintaining the accessibility of the updated policy via the same URI.

Aspect 30. The system of any previous Aspect, wherein the memory further stores instructions that, when executed by the processor, cause the system to: Alert end users regarding updates to the privacy policy via electronic communication.

Aspect 31. The system of any previous Aspect, wherein the memory further stores instructions that, when executed by the processor, cause the system to: Maintain a version history of the privacy policy documents generated and updated over time.

Aspect 32. The system of any previous Aspect, wherein the memory further stores instructions that, when executed by the processor, cause the system to: Validate the generated privacy policy against a set of predefined compliance checks to ensure adherence to the applicable privacy regulations.

Aspect 33. A privacy policy management computing system, comprising: A data reception module configured to receive business practice information from a corporate entity; A clause determination module configured to select privacy policy clauses from a data store based on the received information and privacy regulations; A policy generation module configured to create a privacy policy from the selected clauses; A URI provision module configured to provide a URI for the privacy policy's display; A monitoring module configured to detect changes in business practices or regulations; and An updating module configured to revise the privacy policy in response to detected changes, with the revised policy being accessible through the provided URI.

Aspect 34. The system of any previous Aspect, wherein the data reception module is further configured to: Receive updates to the business practice information in real-time from the corporate entity's operational systems.

Aspect 35. The system of any previous Aspect, wherein the policy generation module is further configured to: Format the generated privacy policy in multiple languages based on the geographical information related to the corporate entity's operations.

Aspect 36. The system of any previous Aspect, wherein the updating module is further configured to: Implement the updated privacy policy without service interruption, ensuring continuous availability of the privacy policy to end users.

Aspect 37. A privacy policy management system comprising: A structured data store configured to store a plurality of privacy policy clauses; A computing device operatively coupled to the structured data store, the computing device configured to: Select privacy policy clauses from the structured data store based on received business practice information and applicable privacy regulations; Assemble a privacy policy document from the selected clauses; Store the assembled privacy policy document for retrieval and display.

Aspect 38. The system of any previous Aspect, wherein the structured data store is further configured to: Categorize the privacy policy clauses based on jurisdictional applicability and industry-specific regulations.

Aspect 39. The system of any previous Aspect, wherein the computing device is further configured to: Automatically update the structured data store with new privacy policy clauses in response to changes in privacy regulations.

Aspect 40. The system of any previous Aspect, wherein the computing device is further configured to: Provide an interface for the corporate entity to manually input or update business practice information, which is used to select privacy policy clauses.

Aspect 41. A system for managing privacy policy data, comprising: A structured data store containing categorized privacy policy clauses; A data processing unit configured to: Retrieve relevant clauses from the structured data store based on criteria derived from corporate entity information and regulatory requirements; Compile a customized privacy policy using the retrieved clauses; Update the structured data store with modifications to existing clauses or addition of new clauses as regulations evolve.

Aspect 42. The system of any previous Aspect, wherein the data processing unit is further configured to: Generate alerts when the structured data store receives new clauses or when existing clauses are modified.

Aspect 43. The system of any previous Aspect, wherein the data processing unit is further configured to: Perform version control on the privacy policy documents, tracking changes and updates over time.

Aspect 44. The system of any previous Aspect, wherein the structured data store is further configured to: Interface with external regulatory databases to automatically import updates to privacy regulations.

Aspect 45. A computing system for privacy policy generation and storage, comprising: A memory storing a structured data store with a library of privacy policy clauses indexed by regulatory criteria; A processor programmed to: Query the structured data store for clauses that match specific business practice information and compliance needs; Generate a privacy policy by integrating the matched clauses; Maintain a log of privacy policy versions in the structured data store.

Aspect 46. The system of any previous Aspect, wherein the processor is further programmed to: Validate the generated privacy policy against a checklist of compliance points before storing it in the structured data store.

Aspect 47. The system of any previous Aspect, wherein the memory is further configured to: Encrypt the privacy policy documents stored within the structured data store to ensure data security.

Aspect 48. The system of any previous Aspect, wherein the processor is further programmed to: Provide a backup and recovery mechanism for the structured data store to prevent data loss and ensure continuity of privacy policy availability.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A method of privacy policy management comprising:
receiving, at a computing device, a request from a corporate entity to monitor a privacy policy;
receiving, at the computing device, from the corporate entity, business practice information comprising one or more of:
vendor information related to one or more vendors associated with the corporate entity,
customer information related to one or more customers of the corporate entity, or
corporate information associated with the corporate entity;
determining, by the computing device and based at least on the received information and one or more regulations regarding privacy policies, one or more privacy policy clauses for inclusion in a privacy policy;
generating, at the computing device, a first privacy policy based on the one or more determined privacy policy clauses;
providing, to the corporate entity, a Uniform Resource Indicator (URI) that causes display of the generated first privacy policy;
monitoring, by the computing device, the corporate entity for changes in the business practice information or changes to the one or more regulations regarding privacy policies; and
responsive to determining one or more changes:
determining one or more updated privacy policy clauses for inclusion in an updated privacy policy, and
generating the updated privacy policy based on the one or more updated privacy policy clauses, such that the URI causes display of the updated privacy policy in place of the first privacy policy.

2. The method of claim 1, further comprising:
responsive to determining the one or more changes, providing, to the corporate entity, a notice to be delivered to one or more end users related to the updated privacy policy.

3. The method of claim 1, further comprising:
responsive to determining the one or more changes, causing a notice related to the updated privacy policy to be delivered to one or more end users.

4. The method of claim 1, wherein determining the one or more privacy policy clauses for inclusion in a privacy policy comprises selecting one or more privacy policy clauses from a structured data store comprising a plurality of candidate privacy clauses, wherein the clauses are selected based at least on the received information and one or more regulations regarding privacy policies.

5. The method of claim 1, wherein generating the first privacy policy comprises publishing the first privacy policy in a human-readable form compliant with one or more privacy regulations.

6. The method of claim 5, wherein generating the updated privacy policy comprises replacing the first privacy policy with the updated privacy policy.

7. The method of claim 1, wherein receiving the business practice information comprises the corporate entity providing at least a portion of the business practice information as a structured data file.

8. The method of claim 1, wherein receiving the business practice information comprises:
monitoring activity on a corporate network, and
inferring at least a portion of the business practice information based on the monitored activity.

9. The method of claim 1, wherein providing the URI comprises causing the corporate entity to publish the URI in a publicly available location.

10. A system comprising:
at least one device including a hardware processor;
a memory for storing instructions that, when executed by the at least one device, cause the system to perform operations comprising:
receiving, at the computing device, from the corporate entity, business practice information comprising one or more of:
vendor information related to one or more vendors associated with the corporate entity,
customer information related to one or more customers of the corporate entity, or
corporate information associated with the corporate entity;
determining, by the computing device and based at least on the received information and one or more regulations regarding privacy policies, one or more privacy policy clauses for inclusion in a privacy policy;
generating, at the computing device, a first privacy policy based on the one or more determined privacy policy clauses;
providing, to the corporate entity, a Uniform Resource Indicator (URI) that causes display of the generated first privacy policy;
monitoring, by the computing device, the corporate entity for changes in the business practice information or changes to the one or more regulations regarding privacy policies; and
responsive to determining one or more changes:
determining one or more updated privacy policy clauses for inclusion in an updated privacy policy, and
generating the updated privacy policy based on the one or more updated privacy policy clauses, such that the URI causes display of the updated privacy policy in place of the first privacy policy.

11. The system of claim 10, the operations further comprising:
responsive to determining the one or more changes, providing, to the corporate entity, a notice to be delivered to one or more end users related to the updated privacy policy.

12. The system of claim 10, the operations further comprising:
responsive to determining the one or more changes, causing a notice related to the updated privacy policy to be delivered to one or more end users.

13. The system of claim 10, wherein determining the one or more privacy policy clauses for inclusion in a privacy policy comprises selecting one or more privacy policy clauses from a structured data store comprising a plurality of candidate privacy clauses, wherein the clauses are selected based at least on the received information and one or more regulations regarding privacy policies.

14. The system of claim 10, wherein generating the first privacy policy comprises publishing the first privacy policy in a human-readable form compliant with one or more privacy regulations.

15. The system of claim 14, wherein generating the updated privacy policy comprises replacing the first privacy policy with the updated privacy policy.

16. The system of claim 10, wherein receiving the business practice information comprises the corporate entity providing at least a portion of the business practice information as a structured data file.

17. The system of claim 10, wherein receiving the business practice information comprises:
monitoring activity on a corporate network, and
inferring at least a portion of the business practice information based on the monitored activity.

18. The system of claim 10, wherein providing the URI comprises causing the corporate entity to publish the URI in a publicly available location.

19. One or more non-transitory computer readable media comprising instructions which, when executed by one or more hardware processors, causes performance of operations comprising:
receiving, at the computing device, from the corporate entity, business practice information comprising one or more of:
vendor information related to one or more vendors associated with the corporate entity,
customer information related to one or more customers of the corporate entity, or
corporate information associated with the corporate entity;
determining, by the computing device and based at least on the received information and one or more regulations regarding privacy policies, one or more privacy policy clauses for inclusion in a privacy policy;
generating, at the computing device, a first privacy policy based on the one or more determined privacy policy clauses;
providing, to the corporate entity, a Uniform Resource Indicator (URI) that causes display of the generated first privacy policy;
monitoring, by the computing device, the corporate entity for changes in the business practice information or changes to the one or more regulations regarding privacy policies; and
responsive to determining one or more changes:
determining one or more updated privacy policy clauses for inclusion in an updated privacy policy, and
generating the updated privacy policy based on the one or more updated privacy policy clauses, such that the URI causes display of the updated privacy policy in place of the first privacy policy.

20. The one or more computer-readable media of claim 19, wherein generating the first privacy policy comprises publishing the first privacy policy in a human-readable form compliant with one or more privacy regulations, and wherein generating the updated privacy policy comprises replacing the first privacy policy with the updated privacy policy.
